(19) United States
(12) Patent Application Publication
(10) Pub. No.: US 2026/0352602 A1
(43) Pub. Date: Nov. 5, 2026

(54) DATA COLLECTION SYSTEM

(71) Applicant: NTT, Inc., Tokyo (JP)

(72) Inventors: Ryohei TSUGAMI, Tokyo (JP); Tatsuya FUKUI, Tokyo (JP)

(73) Assignee: NTT, Inc., Tokyo (JP)

(21) Appl. No.: 19/486,914

(22) PCT Filed: May 26, 2023
(86) PCT No.: PCT/JP2023/019721

§ 371 Date: Nov. 21, 2025

(51) Int. Cl. H04L 47/28; H04L 67/1097

(52) U.S. Cl. CPC H04L 47/28; H04L 67/1097

(57) ABSTRACT

According to the present disclosure, there is provided a transmission control device including: a function of calculating, in a plurality of data sources, a satisfaction level with a data transfer requirement for each data source; and a function of performing transmission control of the plurality of data sources so that a sum of the satisfaction levels of the plurality of data sources becomes larger.

### TECHNICAL FIELD

The present disclosure relates to a transmission control technology in a data collection system.

### BACKGROUND ART

With the spread of Internet of Things (IoT) and remote work, communication traffic continues to increase year by year. When a large amount of data generated from a wide variety of sensors is transmitted to a server, processing of communication on a reception side may run into bottlenecks in communication methods in the related art. In addition, an increase in load of a central processing unit (CPU) may result in deterioration in reception processing performance or an increase in power consumption.

In remote direct memory access (RDMA), there is an effect of reducing a CPU load by not performing memory copy which causes bottlenecks in transmission control protocol (TCP) of techniques in the related art. However, since a low-loss network is required for performing data transmission by using RDMA, RDMA cannot be directly used in a current wide area network.

As a method of using RDMA in a network in which a packet loss occurs, a method of using priority flow control (PFC) and a method of including a retransmission control mechanism in a server are considered, but there are issues including a possibility of deadlock, an increase in load of a server, and the like.

In order to implement data transmission by RDMA in a wide area network, a system is proposed in which a data transfer requirement is sent from a data source to a controller, the controller that receives the requirement determines a transmission policy of each data source and delivers the transmission policy to the data source, each data source autonomously requests the controller to establish a communication path based on the transmission policy, and performs data transmission after the establishment of the communication path (see, for example, Patent Literature 1 and Non Patent Literature 1).

### CITATION LIST

### Patent Literature

Patent Literature 1: WO2023/012878

### Non Patent Literature

Non Patent Literature 1: Ryouhei Tsugami, Tatsuya Fukui, “Usage Control Method of Communication Path for Wide-area/Multi-device RDMA Data Collection”, IEICE Technical Report, vol. 122, no. 14, CS2022-7, pp. 25-30, May 2022.

### SUMMARY OF INVENTION

### Technical Problem

A data transfer requirement is set for each data transmitted from a data source, but the data transfer requirement is not necessarily satisfied during system operation in some cases. In this respect, an object of the present disclosure is to use a satisfaction level with a data transfer requirement as an index and determine a transmission policy on the basis of the satisfaction level.

### Solution to Problem

A data collection system of the present disclosure includes: a transmission control device of the present disclosure; a plurality of data sources that perform data transmission depending on control from the transmission control device; and a server that collects data transmitted from the plurality of data sources.

A transmission control device of the present disclosure includes: a function of calculating, in a plurality of data sources, a satisfaction level with a data transfer requirement for each data source; and a function of performing transmission control of the plurality of data sources so that a sum of the satisfaction levels of the plurality of data sources becomes larger.

The transmission control device of the present disclosure executes a control method of the present disclosure. The control method of the present disclosure includes: a procedure of calculating, in a plurality of data sources, a satisfaction level with a data transfer requirement for each data source by a transmission control device; and a procedure of performing transmission control of the plurality of data sources so that a sum of the satisfaction levels of the plurality of data sources becomes larger by the transmission control device.

The data transfer requirement may include a delay requirement. In this case, the transmission control device of the present disclosure may acquire delays in the plurality of data sources and calculate a ratio of a delay to the delay requirement for each data source, as a satisfaction level with the data transfer requirement.

The transmission control device of the present disclosure may calculate a resource use amount used by the plurality of data sources in a communication network and increase the sum of the satisfaction levels such that the resource use amount falls within a predetermined threshold. At this time, the transmission control device of the present disclosure may calculate the resource use amount by using a generated data size, a data generation frequency, and a data accumulation amount of the plurality of data sources.

Transmission control of the plurality of data sources may include a data accumulation amount accumulated in at least one of the plurality of data sources, and the plurality of data sources may perform the data transmission when the data of the data accumulation amount defined in a host device is accumulated.

Note that the disclosures described above can be combined in any possible manner.

### Advantageous Effects of Invention

According to the present disclosure, a satisfaction level with a data transfer requirement is used as an index, and a transmission policy is determined on the basis of the satisfaction level. Therefore, the data collection system of the present disclosure that collects data can satisfy the data transfer requirement of more data sources.

### BRIEF DESCRIPTION OF DRAWINGS

FIG. 1 illustrates a system configuration example of the present disclosure.

FIG. 2 illustrates an example of a data transmission sequence.

FIG. 3 illustrates a configuration example of a server.

FIG. 4 illustrates a configuration example of a data source.

FIG. 5 illustrates an example of information stored in a requirement table of each data source.

FIG. 6 illustrates a configuration example of a transmission control device.

FIG. 7 illustrates an example of an operation in the transmission control device.

FIG. 8 illustrates an example of a transmission policy determination flow in a transmission policy determination unit.

### DESCRIPTION OF EMBODIMENTS

Hereinafter, embodiments of the present disclosure will be described in detail with reference to the drawings. Note that, the present disclosure is not limited to the embodiments described below. These embodiments are merely examples, and the present disclosure can be implemented in a form with various modifications and improvements based on the knowledge of those skilled in the art. Note that components having the same reference numerals in the present description and the drawings indicate the same components.

### Overview of Present Disclosure

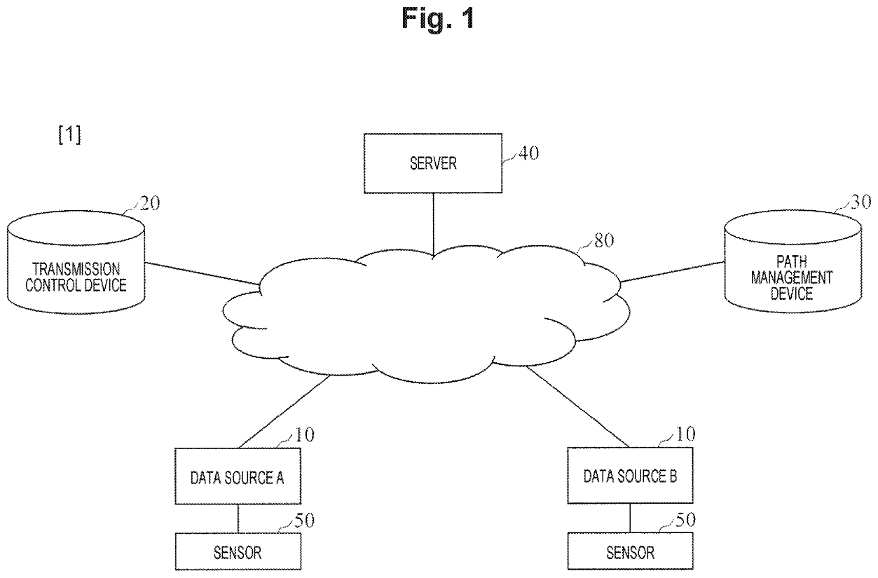

FIG. 1 illustrates a system configuration example of the present disclosure. A system of the present disclosure includes a plurality of data sources 10, a transmission control device 20, a path management device 30, and a server 40. The plurality of data sources 10, the transmission control device 20, the path management device 30, and the server 40 are connected by a communication network 80.

The data source 10 is a terminal holding user-side data such as sensing data acquired by a sensor 50. The server 40 is a terminal that collects data from the data sources 10. The communication network 80 is any means that enables a packet to be transferred and may include a public network regardless of a wired or wireless public network.

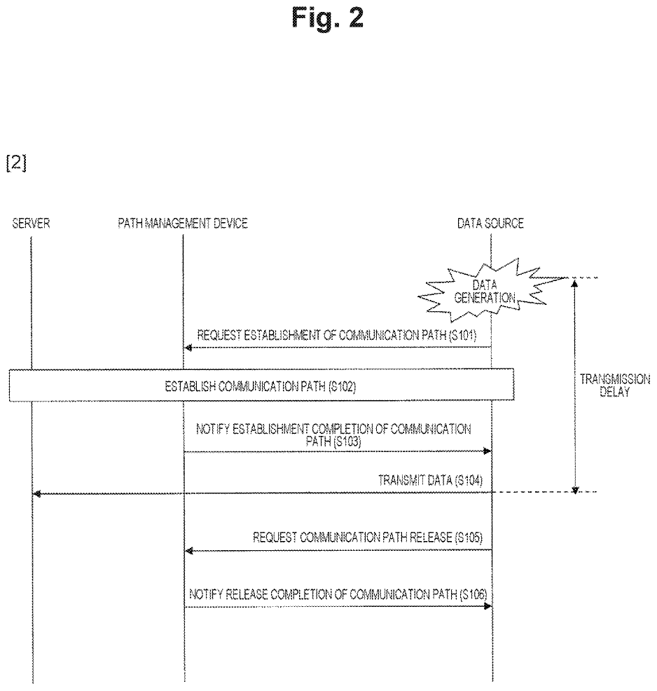

FIG. 2 illustrates an example of a data transmission sequence. In the data collection system of the present disclosure, the path management device 30 establishes a communication path such that data transmission from the data source 10 to the server 40 is performed. At this time, the data collection system of the present disclosure executes the following sequence.

The data source 10 requests establishment of a communication path (S101).

The path management device 30 establishes a communication path (S102), and then transmits a communication path establishment completion notification (S103).

The data source 10 performs data transmission (S104), and then transmits a communication path release request (S105).

The path management device 30 releases the communication path, and then transmits a communication path release completion notification (S106).

A timing of procedure S101 in the data transmission sequence is determined in a transmission policy of the data source 10. The transmission policy includes, for example, the following examples.

First transmission policy: Data transmission is performed immediately after data generation.

Second transmission policy: Data transmission is performed when data of a data accumulation amount determined in a host device is accumulated.

FIG. 2 illustrates an example in which the data source 10 transmits data in accordance with the first transmission policy. A time from generation of data to data transmission (S104) becomes a delay. Among the data of the data source 10, data with strict delay requirements and data with loose delay requirements are mixed. If the delay requirement is loose, there is no need to perform the transmission in accordance with the first transmission policy, and the transmission can be performed in accordance with the second transmission policy. In this respect, in the following embodiment, as the satisfaction level with the data transfer requirement, a satisfaction level with the delay requirement is used as an index, and the transmission policy is determined on the basis of the satisfaction level.

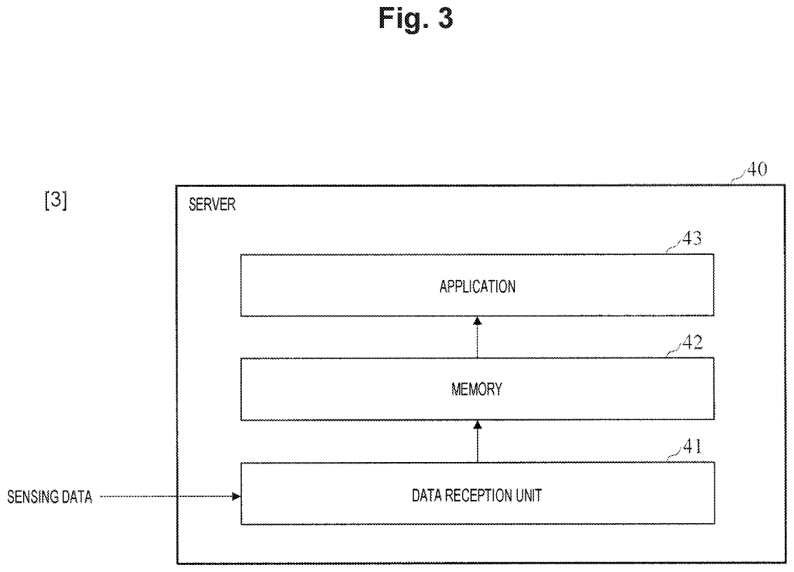

FIG. 3 illustrates a configuration example of the server 40. The server 40 includes a data reception unit 41, a memory 42, and an application 43.

The data reception unit 41 receives data from each data source 10.

The memory 42 stores data from the sensor 50.

The application 43 collects the data from the sensor 50. The application 43 is any application that collects any data detected or generated by a user terminal, a sensor, an in-vehicle system, or the like.

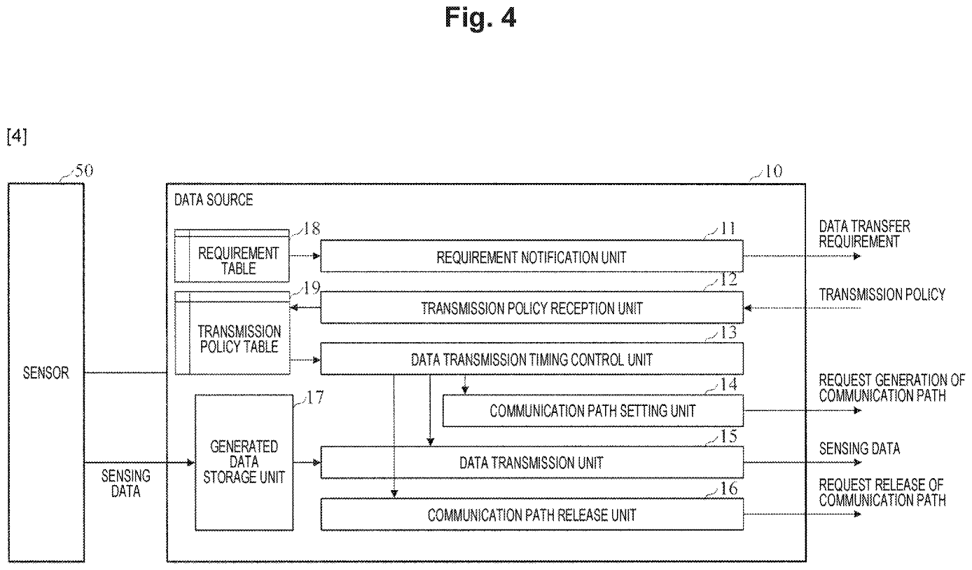

FIG. 4 illustrates a configuration example of the data source 10. The data source 10 includes a requirement notification unit 11, a transmission policy reception unit 12, a data transmission timing control unit 13, a communication path setting unit 14, a data transmission unit 15, a communication path release unit 16, a generated data storage unit 17, a requirement table 18, and a transmission policy table 19.

The generated data storage unit 17 stores the data from the sensor 50.

The requirement notification unit 11 reads a data transfer requirement from the requirement table 18 and notifies the transmission control device 20 of the read data transfer requirement.

The transmission policy reception unit 12 receives the transmission policy from the transmission control device 20.

The data transmission timing control unit 13 controls the communication path setting unit 14, the data transmission unit 15, and the communication path release unit 16 according to the transmission policy table 19.

The communication path setting unit 14 transmits an establishment request of a path to the path management device 30.

The data transmission unit 15 transmits data stored in the generated data storage unit 17 to the server 40.

The communication path release unit 16 transmits a release request of a path to the path management device 30.

The requirement table 18 stores the data transfer requirement for each data source 10.

The transmission policy table 19 stores a policy for a case where the data is transmitted from the data source 10 to the server 40.

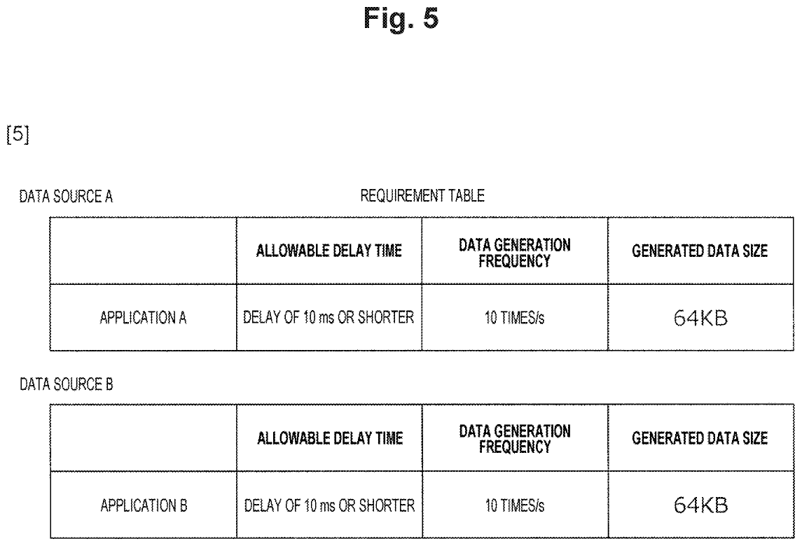

FIG. 5 illustrates an example of information stored in the requirement table 18 of each data source. Each requirement table stores, as the data transfer requirement, an allowable delay time d_{i_req}, a data generation frequency, and a generated data size of each data source 10 in association with the application. The allowable delay time is an allowable delay time from generation of data to arrival at the server 40 and corresponds to a delay requirement. The generated data size is a data amount generated at a time in the sensor 50.

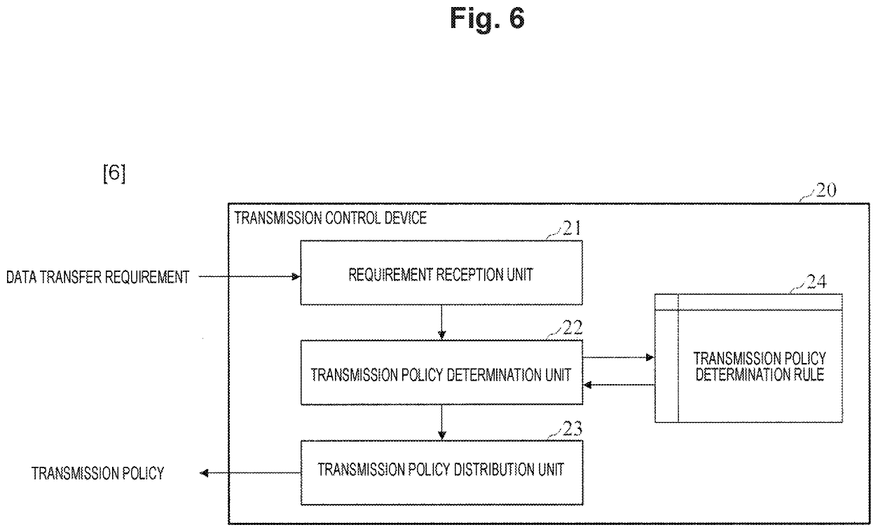

FIG. 6 illustrates a configuration example of the transmission control device 20. The transmission control device 20 includes a requirement reception unit 21, a transmission policy determination unit 22, a transmission policy distribution unit 23, and a transmission policy determination rule 24.

The transmission policy determination unit 22 includes a function of calculating, in the plurality of data sources 10, a satisfaction level with a data transfer requirement for each data source 10, and a function of performing transmission control of the plurality of data sources 10 so that a sum of the satisfaction levels of the plurality of data sources 10 becomes larger. In the present embodiment, an example is described in which the data transfer requirement includes the allowable delay time d_{i_req} and the transmission policy determination unit 22 has a function of acquiring an average delay time dᵢ in the plurality of data sources 10 and a function of calculating a ratio of the average delay time dᵢ to the allowable delay time d_{i_req} for each data source 10, as the satisfaction level with the data transfer requirement.

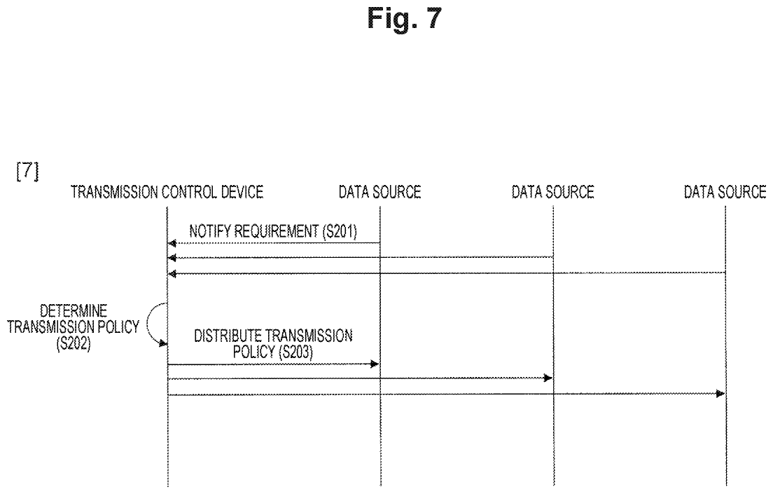

FIG. 7 illustrates an example of an operation in the transmission control device 20.

Each data source 10 notifies the transmission control device 20 of the data transfer requirement on the basis of information of the requirement table 18 (S201).

The data transfer requirement includes the allowable delay time d_{i_req} the data generation frequency, and the generated data size of each data source 10 as illustrated in FIG. 5.

The requirement reception unit 21 of the transmission control device 20 receives the data transfer requirement from the data source 10. The transmission policy determination unit 22 determines a transmission policy for each data source 10 according to the data transfer requirement in accordance with the transmission policy determination rule 24 (S202).

The transmission policy distribution unit 23 of the transmission control device 20 distributes the determined transmission policy to each data source 10 (S203).

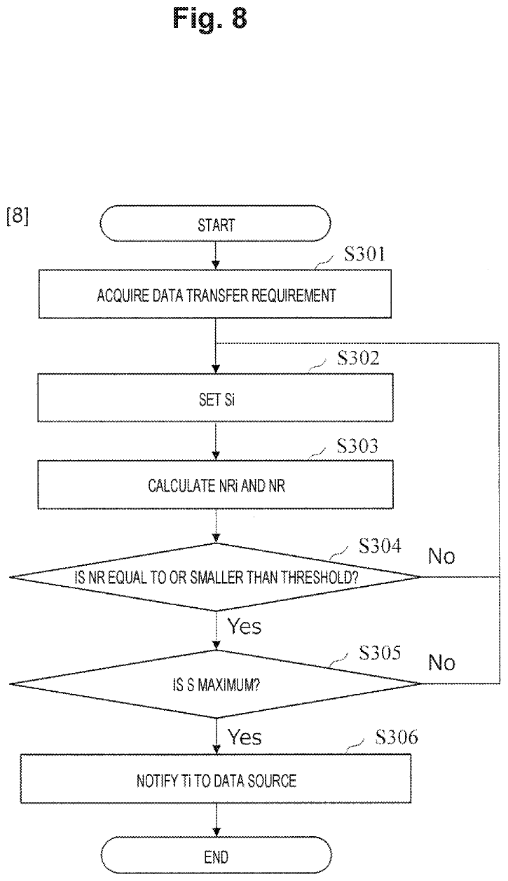

FIG. 8 illustrates an example of a transmission policy determination flow in the transmission policy determination unit 22. The transmission policy determination unit 22 acquires the data transfer requirement of each data source 10 (S301), sets a delay requirement satisfaction level Sᵢ for each i-th data sources 10 (S302), calculates a resource use amount NRᵢ used by the i-th data source 10 at the time of the setting in the communication network 80 and a total resource use amount NR of all the data sources 10 (S303), and adjusts the delay requirement satisfaction level Sᵢ of each data source 10 (S302) such that the total resource use amount NR becomes equal to or smaller than a threshold (S304) and a sum S of the delay requirement satisfaction levels Sᵢ is maximized (S305).

When the sum S of the delay requirement satisfaction levels Sᵢ becomes the maximum (Yes in S305), the transmission policy distribution unit 23 transmits, as the transmission policy to the i-th data source 10, a data accumulation amount Tᵢ according to the data source 10 (S306). Consequently, the data accumulation amount Tᵢ is stored in the transmission policy table 19 of each data source 10. The data source 10 in which the data accumulation amount Tᵢ is stored in the transmission policy table 19 performs data transmission when data of the data accumulation amount Tᵢ is accumulated in accordance with the second transmission policy.

In step S301, the data transfer requirement includes the allowable delay time d_{i_req}, the average delay time dᵢ, a data generation frequency Fᵢ, and a generated data size Pᵢ of each data source 10. Here, the generated data size Pᵢ is the amount of data generated one time in a data source i.

In step S302, the delay requirement satisfaction level Sᵢ of the data source i can be represented by the following equation using the average delay time dᵢ and the allowable delay time d_{i_req} of the data source i.

Sᵢ=dᵢ/d_{i_req}

Here, for the data source i in which the data accumulation amount Tᵢ is already included in the transmission policy, the average delay time dᵢ can be obtained by the following equation using the generated data size Pᵢ, the data generation frequency Fᵢ, and the data accumulation amount Tᵢ of the data source i.

dᵢ=Fᵢ*Pᵢ/Tᵢ

In step S303, the resource use amount NRᵢ of the i-th data source 10 can be represented by the following equation.

$$\begin{matrix}[ Math . 1 ] & \\ {NR}_{i} = \frac{{F}_{i} {P}_{i}}{{T}_{i}} * ( \frac{{T}_{i}}{BW} + H ) * BW & ( 1 )\end{matrix}$$

Here, BW denotes a communication band to be used, and H denotes path establishment overhead.

Therefore, the total resource use amount NR used by all the data sources 10 in the communication network 80 can be represented by the following equation.

$$\begin{matrix}[ Math . 2 ] & \\ NR = {\sum }_{i = J}^{n} \{ \frac{{F}_{i} {P}_{i}}{{T}_{i}} * ( \frac{{T}_{i}}{BW} + H ) * BW \} & ( 2 )\end{matrix}$$

As described above, the transmission policy determination unit 22 has a function of calculating the total resource use amount NR used by the plurality of data sources 10 in the communication network 80 by using generated data sizes Pᵢ, data generation frequencies Fᵢ, and data accumulation amounts Tᵢ of the plurality of data sources 10, and a function of increasing the sum S of the satisfaction levels so that the total resource use amount NR falls within a predetermined threshold.

The threshold in step S304 is a total amount of network resources that can be used in the communication network 80 and can be randomly set. In addition, the sum S of the delay requirement satisfaction levels Sᵢ in step S305 is represented by the following equation.

$$\begin{matrix}[ Math . 3 ] & \\ S = {\sum }_{i = J}^{n} {S}_{i} & ( 3 )\end{matrix}$$

In step S306, the transmission policy distribution unit 23 transmits, as the transmission policy, the data accumulation amount Tᵢ according to the delay requirement satisfaction level Sᵢ to the i-th data source 10. A specific method of calculating the data accumulation amount Tᵢ can be exemplified as follows.

### (Regarding Data Source Having Strict Delay Requirement)

Assuming that the delay requirement satisfaction level Sᵢ of the data source i having a strict delay requirement is 1, the data accumulation amount Tᵢ of the data source i is obtained by the following equation from Equation (1).

Tᵢ=Fᵢ*Pᵢ/d_{i_reg} (4)

However, BW and H are included in the average delay time dᵢ, thus being excluded.

In the case of the data source i having the data generation frequency Fᵢ=10 times/s, the generated data size Pᵢ=64 KB, and the allowable delay time d_{i_req}=10 ms, 64,000 KB=64 MB is obtained from Equation (4).

### (Regarding Data Source Having Unstrict Delay Requirement)

Assuming that the delay requirement satisfaction level of the data source i having a strict delay requirement is set Sᵢ=0.5, for example, the data accumulation amount Tᵢ of the data source i is obtained by the following equation from Equation (1).

Tᵢ=2*Fᵢ*Pᵢ/d_{i_req} (5)

However, BW and H are included in the average delay time dᵢ, thus being excluded.

In the case of the data source i having the data generation frequency Fᵢ=10 times/s, the generated data size Pᵢ=64 KB, and the allowable delay time d_{i_req}=10 ms, 128,000 KB=128 MB is obtained from Equation (5).

When the data accumulation amount is received as the transmission policy, each data source 10 performs the data transmission when the data of the data accumulation amount defined in a host device is accumulated.

For example, when a delay requirement of a data source A is strict and the data accumulation amount Tᵢ is 64 MB, the data source A requests the path management device 30 to establish a communication path when 64 MB of sensing data is accumulated.

For example, when a delay requirement of a data source B is not strict and the data accumulation amount Tᵢ is 128 MB, the data source B requests the path management device 30 to establish a communication path when 128 MB of sensing data is accumulated.

As described above, the data collection system of the present embodiment uses the delay requirement satisfaction level Sᵢ as an index and determines the data accumulation amount Tᵢ so that the sum S of the delay requirement satisfaction levels Sᵢ is maximized. Consequently, in the present embodiment, the transmission policy that defines a data transmission timing of each data source 10 can be determined so that the sum S of the delay requirement satisfaction levels Sᵢ is maximized.

Here, in the present embodiment, the sum S of the delay requirement satisfaction levels Sᵢ is maximized within a range of resources of the communication network 80. Therefore, in the present embodiment, each data source 10 performs data transmission on the basis of the transmission policy, and thus, it is possible to perform transmission control to make the most effective use of the resources of the communication network 80.

### OTHER EMBODIMENTS

Note that a parameter for the transmission control performed based on the delay requirement satisfaction level Sᵢ is not limited to the data accumulation amount Tᵢ, and may be any parameter in the transmission policy. Therefore, the present disclosure enables data to be efficiently transmitted to the server 40 even when there is a delay in a wide area network.

In addition, in the above-described embodiments, the transmission control is performed using the delay requirement satisfaction level Sᵢ as the index. However, instead of or together with the delay requirement satisfaction level Sᵢ, a satisfaction level with any requirement included in the data transfer requirement can be used as an index.

In addition, in the above-described embodiments, an example is described in which the transmission control device 20 and the path management device 30 are separately arranged, but these control devices may be provided in a common device or may be configured of a plurality of devices arranged in a distributed manner.

In addition, in the above-described embodiments, an example is described in which the data collection system includes the path management device 30, but the data collection system of the present disclosure is not limited thereto. For example, the data collection system of the present disclosure may collect data from the data sources 10 to the server 40 without using a communication path established by the path management device 30.

In addition, the transmission control device 20 according to the present invention can also be implemented by a computer and a program, and the program can be recorded in a recording medium or provided through a network. A program of the present disclosure is a program for causing a computer to implement the functional units included in the transmission control device 20 according to the present disclosure, and is a program for causing a computer to execute the procedures included in the method executed by the transmission control device 20 according to the present disclosure.

### REFERENCE SIGNS LIST

10, 10A, 10B Data source
20 Transmission control device
30 Path management device
40 Server
50 Sensor
11 Requirement notification unit
12 Transmission policy reception unit
13 Data transmission timing control unit
14 Communication path setting unit
15 Data transmission unit
16 Communication path release unit
17 Generated data storage unit
18 Requirement table
19 Transmission policy table
21 Requirement reception unit
22 Transmission policy determination unit
23 Transmission policy distribution unit
24 Transmission policy determination rule
41 Data reception unit
42 Memory
43 Application

1. A transmission control device comprising:
a memory; and
a processor executing computer-executable instructions that cause the transmission control device to perform operations comprising:
calculating, in a respective data source of a plurality of data sources, a satisfaction level of the respective data source according to a data transfer requirement of the respective data source; and
performing transmission control of the plurality of data sources, thereby maximizing a sum of respective satisfaction levels of the plurality of data sources.

2. The transmission control device according to claim 1, wherein
the data transfer requirement includes a delay requirement, and
the computer-executable instructions further cause the transmission control device to perform operations comprising:
acquiring a delay of a respective data source of in the plurality of data sources, and
calculating a ratio of the delay to the delay requirement for the respective data source of the plurality of data sources, and the ratio represents a satisfaction level with the data transfer requirement.

3. The transmission control device according to claim 1, wherein the computer-executable instructions further cause the transmission control device to perform operations comprising:
calculating a resource use amount used by the respective data source of the plurality of data sources in a communication network; and
increasing the sum of the satisfaction levels such that the resource use amount falls within a predetermined threshold.

4. The transmission control device according to claim 3, wherein the computer-executable instructions further cause the transmission control device to perform operations comprising
calculating the resource use amount based on a generated data size, a data generation frequency, and a data accumulation amount of the plurality of data sources.

5. A data collection system comprising:
the transmission control device according to claim 1, wherein
the respective data source of the plurality of data sources performs data transmission depending on control from the transmission control device, and
a server collects data transmitted from the plurality of data sources.

6. The data collection system according to claim 5, wherein
transmission control of the plurality of data sources includes a data accumulation amount accumulated in at least one of the plurality of data sources, and
the plurality of data sources performs the data transmission when the data of the data accumulation amount defined in a host device is accumulated.

7. A control method comprising:
calculating, in a respective data source of a plurality of data sources, a satisfaction level of the respective data source according to a data transfer requirement of the respective data source; and
performing transmission control of the plurality of data sources, thereby maximizing a sum of restive satisfaction levels of the plurality of data sources.

8. A computer-readable non-transitory recording medium storing a computer-executable program instructions that when executed by a processor cause a transmission control device to execute operations according to claim 1.
